(19) United States
(12) Patent Application Publication
(10) Pub. No.: US 2010/0091637 A1
(43) Pub. Date: Apr. 15, 2010

(54) METHOD AND APPARATUS FOR PERFORMING A WRITING POWER CALIBRATION

(75) Inventors: Sander Jan Klerk, Son (NL); Maarten Kuijper, Kuijper (NL); Tony Petrus Van Endert, Lommel (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/439,693

(22) PCT Filed: Sep. 5, 2007
(86) PCT No.: PCT/IB07/53567

§ 371 Date: Dec. 21, 2009

(30) Foreign Application Priority Data
Sep. 7, 2006 (EP) 06120275.0

(51) Int. Cl. G11B 7/125

(52) U.S. Cl. 369/124.1; G9B/7.101

(57) ABSTRACT

The present invention relates to a method of performing a writing power calibration for optical recording on an optical storage medium having a spiral track structure, comprising the steps of: selecting a first partition (10) on the track structure having a first track (12) and an adjacent second track (14) that do both not contain written information on track portions (16, 18) within the first partition (10), wherein the second track (14) may be neighboured by a third track (20) that may have a track portion (22) within the first partition (10) containing written information, writing to the track portion (16) of the first track (12) within the first partition (10) using a predetermined writing power profile of a laser beam, reading information written to the first track (12) within the first partition (10), and determining a relation between an asymmetry value and laser power on the basis of the writing power profile and the information read from the first track (12). The present invention further relates to an apparatus for performing a writing power calibration.

### FIELD OF THE INVENTION

The invention relates to a method of performing a writing power calibration for optical recording on an optical storage medium and to an apparatus by which such a method can be performed. Particularly, the invention relates to a writing power calibration method on the basis of writing and reading information to and from a drive calibration zone on the optical storage medium.

### BACKGROUND OF THE INVENTION

In an optical recorder the writing power of the laser beam should be determined in an optimum way once a new optical storage medium, i.e. an optical disc is inserted. Such a determination of the optimum power is performed by an optimum power control (OPC). The optimum power control of the laser beam is based on an asymmetry measurement (also named β measurement) and on a jitter measurement. The jitter calibration is used to find the optimum power, namely by setting the optimum power to a minimum jitter, while the β measurement is used to correct the writing power during the ongoing writing process. The latter is achieved by determining the slope of the curve relating the laser power with the asymmetry value at the target asymmetry. If a deviation of the β value during recording is noticed, the laser power is changed so as to correct for the shift in the β value. The β measurement is achieved by performing a laser power sweep, i.e. writing with a predetermined laser power profile, and then reading back the written data so as to determine the laser power dependent asymmetry. If for example a target β value of 4% is desired, the corresponding optimum laser power αₒₚₜ can be derived.

Thus, the complete walking optimum power control (WOPC) relies on the β slope initially determined for each recorder-disc combination, hence making the β slope determination quality crucial for the recording result. Thus, when the track on which the power sweep for the asymmetry measurement is influenced by a neighbouring track, for example related to high power and/or a discontinuity in the power sweep, the β measurement result and therefore the WOPC can be seriously deteriorated.

It is therefore an object of the present invention to provide a method and an apparatus for improved optimum power control, particularly for avoiding a deteriorating influence during asymmetry measurement.

### SUMMARY OF THE INVENTION

This object is solved by the method according to claim 1 and the apparatus according to claim 9. Further advantageous developments are outlined in the dependent claims.

In accordance with the invention there is provided a method of performing a writing power calibration for optical recording on an optical storage medium having a spiral track structure, comprising the steps of:

selecting a first partition on the track structure having a first track and an adjacent second track that do both not contain written information on track portions within the first partition, wherein the second track may be neighboured by a third track that may have a track portion containing written information,

writing to the track portion of the first track within the first partition using a predetermined writing power profile of a laser beam,

reading information written to the first track within the first partition, and

determining a relation between an asymmetry value and laser power on the basis of the writing power profile and the information read from the first track.

Thus, the power sweep and the reading back of the power for asymmetry or β measurement is performed on a track that is generally neighboured by two empty tracks. For example, in case that the calibration zone is located at the inner radii of the disc and the use of tracks for calibration is performed in the order of decreasing addresses (ADIP addresses), i.e. backwards with respect to the normal recording direction, the inner tracks of the disc are empty. According to the invention, not the empty track neighbouring a previously recorded track with higher addresses is chosen as the first track to be written to but the next track at a smaller radius or a track at even smaller radii than the mentioned next track. Consequently, the neighbouring empty tracks have no negative influence on the calibration result.

Preferably, after the reading step, information is written to at least a track portion of the second track within a second partition and a track portion of the second track within a third partition of the second track using further predetermined writing power profiles, and a relation between jitter and laser power is determined on the basis of the writing power profiles and information read from the track portion of the first track in the first partition, the track portion of the second track in the second partition, and the track portion of the second track in the third partition. The concept of the present invention according to which a track is left empty during asymmetry calibration is in contrast to conventional schemes in which no tracks are left empty in the disc calibration zone, so as to avoid a waste of disc space. According to the presently discussed preferred embodiment of the present invention, a waste of disc space can also be avoided, since the empty track is used in connection with the jitter measurement after β measurement. Particularly, both tracks, namely the first track on the basis of which the asymmetry measurement is performed, and the second track containing the so-called re-shuffled (for explanation: see below) power sweeps, are used for the purpose of jitter determination and the determination of the laser power that is related to the minimum jitter.

Preferably, the size of the first partition is essentially twice the size of the second partition and essentially twice the size of the third partition. On this basis the re-shuffled power sweeps can be realized. If in the first partition a power sweep from a minimum value up to a maximum value is performed, it is possible to make two power sweeps in the neighbouring track, namely in the second and third partitions, that have essentially the same slope but different power levels at a particular angular position. For example, at the angular position at which in the first partition on the first track the power sweep starts with the minimum power value, the neighbouring re-shuffled power sweep starts at the half maximum power value. In the other neighbouring partition on the second track, the power sweep starts at minimum power and extends up to the half maximum power while in the adjacent region of the first track the power raises from the half maximum power to the maximum power.

This can be realized by a concept wherein the first partition essentially extends over 360 degrees and the second and third partitions each essentially extend over 180 degrees.

It is essential for jitter measurement that the power values of the writing power profiles in adjacent positions of the first and the second tracks are different. Thereby, inhomogeneities of the disc are averaged out.

With respect to the aim of a well behaving walking optimum power control (WOPC) the relation between the asymmetry value β and laser power α is approximated by

β=aα²+bα+c.

On this basis, a walking optimum power control is performed by increasing or decreasing the laser power α by Δα on the basis of a difference Δβ between a measured asymmetry value and a target asymmetry value using the relation

$$Δα = \frac{\partial α}{\partial β} \cdot {Δβ}_{wopc}$$

$$wherein$$

$$\frac{\partial α}{\partial β} = \frac{1}{2 a {α}_{opt} + b} .$$

Thus, the relation between the asymmetry value β and the laser power α is first fitted by a curve of second order. Then, the slope of this curve is determined at the optimum laser power αₒₚₜ. If a difference between the target asymmetry value and the measured asymmetry value is realized during recording, namely by reading back of recently recorded data, the difference being Δβ_{wopc}, the laser power can be shifted by Δα in accordance with the above mentioned equation.

The method according to the present invention is particular useful in the case that the optical storage medium is a Blu-ray Disc (BD). The invention is not restricted to BD but can be used in connection with any media that are adapted for recording, e.g. CD, DVD, HD-DVD, single and double layered. However, the specification of BD with respect to the drive calibration zone allows readily implementing the present invention. If the drive calibration zone is located at the inner side of the disc, unrecorded tracks are present so that the calibration method can be performed on these tracks.

The present invention further relates to an apparatus for performing a writing power calibration for optical recording on an optical storage medium having a spiral track structure, comprising:

means for selecting a first partition on the track structure having a first track and an adjacent second track that do both not contain written information on track portions within the first partition, wherein the second track may be neighboured by a third track that may have a track portion within the first partition containing written information,

means for writing to the track portion of the first track within the first partition using a predetermined writing power profile of a laser beam,

means for reading information written to the first track within the first partition, and

means for determining a relation between an asymmetry value and laser power on the basis of the writing power profile and the information read from the first track.

These and other aspects of the invention will be apparent from and elucidated with reference to the embodiment described herein after.

### BRIEF DESCRIPTION OF THE DRAWINGS

FIG. 1 illustrates the track structure of a disc on which a method according to the present invention is performed.

FIG. 2 illustrates a writing power profile used for determining an asymmetry value.

FIG. 3 illustrates writing power profiles used for determining jitter.

FIG. 4 shows a flow diagram illustrating a writing power calibration method according to the present invention.

FIG. 5 shows a functional diagram illustrating a second order polynomial fit and a β slope determination at the optimum laser power.

FIG. 6 shows a flow diagram illustrating a walking optimum power control method used in connection with the present invention.

### DETAILED DESCRIPTION OF A PREFERRED EMBODIMENT

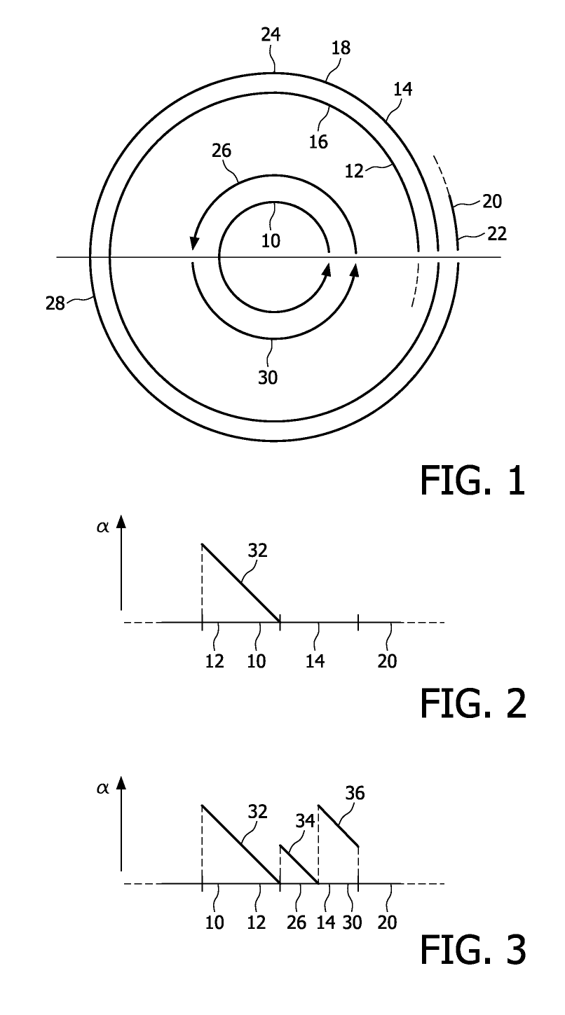

FIG. 1 illustrates the track structure of a disc on which a method according to the present invention is performed. A drive calibration zone of an optical disc is illustrated. The disc has a spiral track structure. Two complete tracks, namely a first track 12 and a second track 14 are shown. Further, the beginning of a third track 20 is illustrated. The drive calibration zone can principally be located at any radius of the disc, but is preferably located at the inner side OPC area. The track structure can be continued in both directions, namely in extension of the third track 20 and to more inner radii from the first illustrated track 12. In order to distinguish between the tracks 12, 14, 20, the track structure is shown with gaps. In fact, the spiral is continuous. Partitions 10, 26, 30 are indicated by arrows. The partitions relate to angular sections of the disc. The first partition 10 extends over approximately 360 degrees, while the second partition 26 and the third partition 30 each extend over 180 degrees.

For determining a relation between an asymmetry value (β value) and laser power, information is written on a portion 16 of the first track 12 within the first partition. In the present example, in which the first partition 10 extends over 360 degrees, the track portion 16 to which information is written is practically the whole first track 12. Before and immediately after writing to the first track 12, also the second track 14 or rather the track portion 18 of the second track 14 within the first partition 10 does not carry written information. Only the third track 20 and further tracks may contain written information within the track portion 22 within the first partition 10. Again, the track portions 18, 22 of the second track 14 and the third track 14, respectively, are practically the whole tracks 14, 22, since the first partition 10 extends over 360 degrees. After the information has been written to the first track 12, it is read back, and the reading process is not deteriorated by a neighbouring track that contains written information, since the second track 14 does not. On the basis of the laser power used and the information read from the first track, β values can be determined in dependence on the laser power.

After the determination of the relation between the asymmetry value and the writing power, the second track 14 can be used for further calibration purposes. Thus, on a track portion 24 of the second track 14 within the second partition 26, a writing power sweep is performed. Similarly, a writing power sweep is performed on the track portion 28 of the second track 14 within the third partition 30. These power sweeps are re-shuffled with respect to the power sweep used for the previous writing to the first track 12 so as to average out inhomogeneities of the disc, in relation to the jitter measurement performed on the basis of the power sweeps in the three partitions 10, 26, 30. This will be further explained with respect to FIGS. 2 and 3.

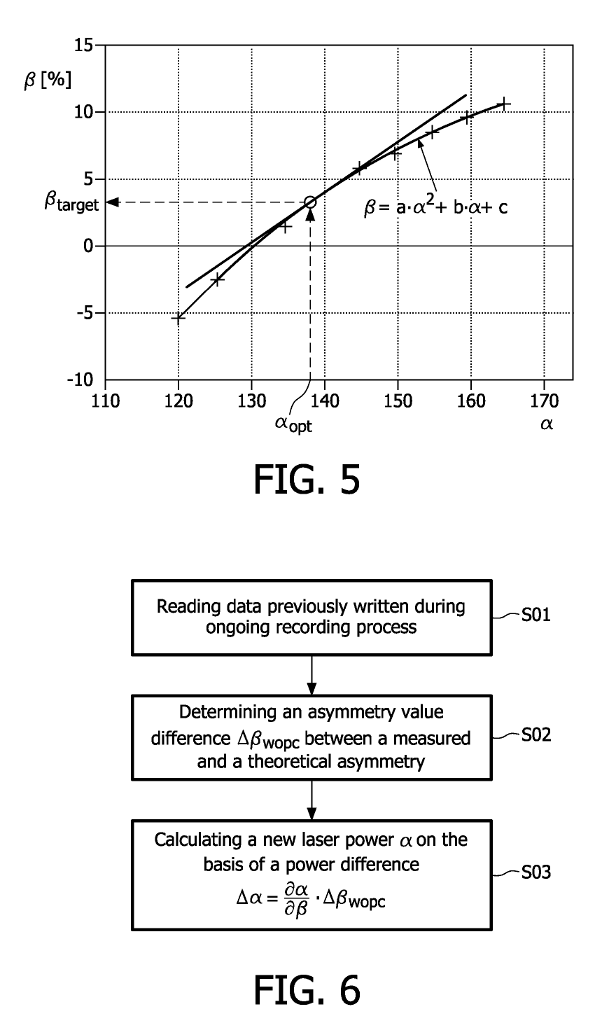

FIG. 2 illustrates a writing power profile used for determining an asymmetry value. FIG. 3 illustrates writing power profiles used for determining jitter. The spiral track structure is shown in a linear representation. A power sweep 32 performed on the first track 12 is shown by means of a functional representation of the laser power α. After this power sweep 32 that consists of a plurality of discrete laser writing pluses of decreasing power, the relation between the asymmetry value and the laser power is determined. This will be further explained with respect to FIG. 5. After having read back the information from the first track 12, further power sweeps 34, 36 are performed on track 14, namely in the second partition 26 and the third partition 30. In the second partition, the laser power starts from a value at half maximum laser power used when writing to the partition 10 on the first track 12, and is decreased to a minimum value. When writing to partition 30 of the second track 14, the laser power starts at the maximum laser power and is decreased to half the maximum laser power. Thereby, it is achieved that neighbouring portions of the adjacent tracks have not been recorded with the same laser power. Consequently, when performing a jitter calibration on the basis of all three power sweeps, inhomogeneities of the discs are averaged out. The jitter calibration is for example performed as described in PCT/IB2004/050592 the disclosure of which is fully incorporated into the present disclosure.

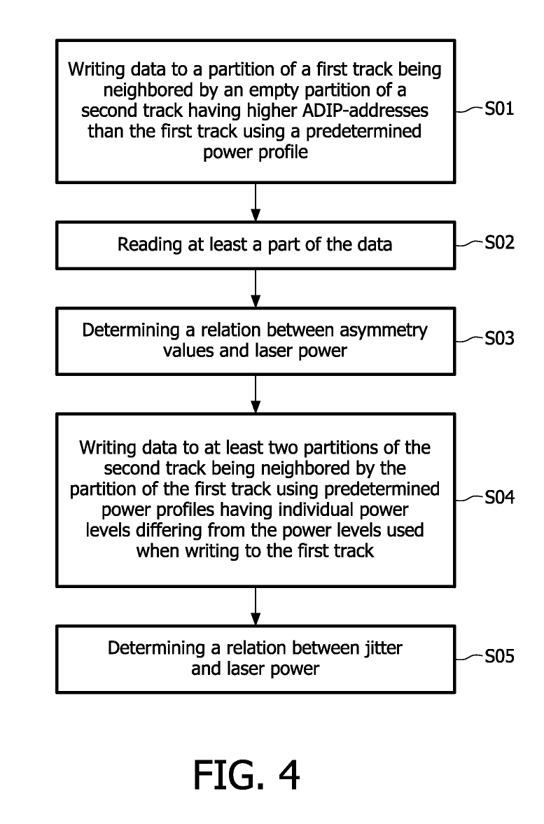

FIG. 4 shows a flow diagram illustrating a writing power calibration method according to the present invention. In a first step S01, data is written on a first track being neighboured by an empty second track. A predetermined laser power profile is used during writing. The empty second track is usually the first empty track that can be found in the disc calibration zone. Thus, the second track has higher ADIP-addresses than the first track. By not using this second track, an influence on the first track used for calibration purposes is avoided.

After the writing, the data are read back in step S02. From the present information, namely the laser power profile and the read back data, a relation between β values and the laser power can be determined in step S03.

Thereafter, data can be written to the second track, i.e. the track that previously has been left empty. Also the writing on the second track is performed with predetermined power profiles in a re-shuffled manner as explained above (step S04). In step S05 a relation between jitter and laser power is determined. By selecting the laser power having the minimum jitter value, an optimum writing can be performed. The information concerning the relation between the β value and the laser power can then be used during the ongoing recording process.

FIG. 5 shows a functional diagram illustrating a second order polynomial fit and a β slope determination at the optimum laser power. From writing onto the first track and reading back the data different asymmetry values can be precisely determined, i.e. without distortion from a neighbouring track. These β values are shown as crosses. The values can be fitted by a second order polynomial fit. From this fit, the slope of the β-α relation can be determined at the target asymmetry value β_{target}, hence the optimum laser power αₒₚₜ. This slope will then be used for the laser power correction during the ongoing recording process, namely by multiplying the observed difference between a measured β value and a target β value by this slope.

FIG. 6 shows a flow diagram illustrating a walking optimum power control method used in connection with the present invention. During the ongoing recording process, data can be read that have previously been written (step S01). On this basis, a β value difference Δβ_{wopc} between a target β value and a measured β value can be determined (step S02). A new laser power adapted to the current writing region of the disc can then be calculated on the basis of multiplying the slope of the β-α relation by the previously determined β value difference Δβ_{wopc}.

1. A method of performing a writing power calibration for optical recording on an optical storage medium having a spiral track structure, comprising the steps of:
selecting a first partition (10) on the track structure having a first track (12) and an adjacent second track (14) that do both not contain written information on track portions (16, 18) within the first partition (10), wherein the second track (14) may be neighboured by a third track (20) that may have a track portion (22) containing written information,
writing to the track portion (16) of the first track (12) within the first partition (10) using a predetermined writing power profile of a laser beam,
reading information written to the first track (12) within the first partition (10), and
determining a relation between an asymmetry value and laser power on the basis of the writing power profile and the information read from the first track (12).

2. The method according to claim 1, wherein, after the reading step, information is written to at least a track portion (24) of the second track (14) within a second partition (26) and a track portion (28) of the second track (14) within a third partition (30) of the second track (14) using further predetermined writing power profiles, and a relation between jitter and laser power is determined on the basis of the writing power profiles and information read from the track portion (16) of the first track (12) in the first partition (10), the track portion (24) of the second track (14) in the second partition (26), and the track portion (28) of the second track (14) in the third partition (30).

3. The method according to claim 2, wherein the size of the first partition (10) is essentially twice the size of the second partition (26) and essentially twice the size of the third partition (30).

4. The method according to claim 2, wherein the first partition (10) essentially extends over 360 degrees and the second and third partitions (26, 30) each essentially extend over 180 degrees.

5. The method according to claim 1 or 2, wherein the power values of the writing power profiles in adjacent positions of the first and the second tracks (12, 14) are different.

6. The method according to claim 1, wherein the relation between the asymmetry value β and laser power α is approximated by
β=aα²+bα+c.

7. The method according to claim 6, wherein a walking optimum power control is performed by increasing or decreasing the laser power α by Δα on the basis of a difference Δβ between a measured asymmetry value and a target asymmetry valueₜ using the relation
$$Δα = \frac{\partial α}{\partial β} \cdot {Δβ}_{wopc}$$
$$wherein$$
$$\frac{\partial α}{\partial β} = \frac{1}{2 a {α}_{opt} + b} .$$

8. The method according to claim 1, wherein the optical storage medium is a Blu-ray Disc (BD).

9. An apparatus for performing a writing power calibration for optical recording on an optical storage medium having a spiral track structure, comprising:
means for selecting a first partition (10) on the track structure having a first track (12) and an adjacent second track (14) that do both not contain written information on track portions (16, 18) within the first partition (10), wherein the second track (14) may be neighboured by a third track (20) that may have a track portion (22) within the first partition (10) containing written information,
means for writing to the track portion (16) of the first track (12) within the first partition (10) using a predetermined writing power profile of a laser beam,
means for reading information written to the first track (12) within the first partition (10), and
means for determining a relation between an asymmetry value and laser power on the basis of the writing power profile and the information read from the first track (12).
